(19) United States
(12) Patent Application Publication
(10) Pub. No.: US 2019/0300388 A1
(43) Pub. Date: Oct. 3, 2019

(54) DEVICE AND METHOD FOR WATER PURIFICATION

(71) Applicant: PIETRO FIORENTINI S.P.A., Arcugnano (VI) (IT)

(72) Inventors: Roberto Rossi, Arese (IT); Paolo Calciolari, Lonigo (IT)

(21) Appl. No.: 16/335,615

(22) PCT Filed: Oct. 6, 2017
(86) PCT No.: PCT/IB2017/056179

§ 371 Date: Mar. 21, 2019

(30) Foreign Application Priority Data
Oct. 7, 2016 (IT) 102016000100786

(51) Int. Cl. C02F 1/28; C02F 1/00; B01D 35/02

(52) U.S. Cl. CPC C02F 1/283; C02F 2101/30; B01D 35/02; C02F 1/001

(57) ABSTRACT

A purification device includes: a hollow body which defines a duct suited to convey water and extending between a first mouth and a second mouth; a purifying material arranged in a first area of the duct between the first and the second mouth, wherein the purifying material is graphene and is held inside the first area (24) by way of one or more holding elements.

### BACKGROUND OF THE INVENTION

### 1. The Field of the Invention

The present invention concerns a water purification device and a water purification method which are particularly suited to be used for the purification of polluted waters.

### 2. The Relevant Technology

As is known, polluted waters are sometimes conveyed into rivers, with serious environmental consequences for the surrounding areas.

It is known that in order to overcome said drawback purification systems are provided which are intended to treat said polluted waters before they are conveyed into rivers.

Said purification systems, however, pose the drawbacks that they are expensive and that they need to be set up in places which are relatively far away from inhabited areas. Consequently, the need arises to provide relatively long pipes suited to convey the water towards and away from the purification system, said pipes being expensive also due to the fact that they must be laid underground.

The increasingly strict requirements of environmental compliance make these drawbacks more and more difficult to manage.

### SUMMARY OF THE INVENTION

The present invention intends to overcome said drawbacks.

In particular, it is one object of the invention to provide a water purification device that is less expensive than the known purification systems described above.

It is also one object of the invention to provide a water purification device that can be used at the point where polluted water is let out.

It is also one object of the invention to provide a water purification device that can be used to reduce the glycol content in water.

It is also one object of the invention to provide a water purification device provided with an active element, meaning the element specifically responsible for the purification action, which can be quickly replaced when its purification capacity has reduced excessively.

It is another, yet not less important object of the invention that the above mentioned exhausted active element can be regenerated.

Advantageously, the possibility to use the device that is the subject of the invention on site eliminates the need to convey the waters produced by several sources, which may even be located far away from the purification system, towards a single purification system, thus avoiding the need to lay expensive pipes.

Still advantageously, the possibility to quickly replace the active element when it is exhausted, offered by the device which is the subject of the invention, limits the costs related to this operation.

Furthermore, advantageously, the possibility to regenerate the active element when it is exhausted makes it possible to limit the overall costs of the device, as it eliminates the need to provide new filtering elements in lieu of the exhausted element.

### BRIEF DESCRIPTION OF THE DRAWINGS

Said objects and advantages, together with others that are described here below, will be highlighted in the following description of a preferred embodiment of the invention, which is provided by way of non-limiting example with reference to the attached drawings, wherein:

FIG. 1 shows a sectional view of the purification device of the invention, according to the longitudinal axis;

FIGS. 2 and 3 show two different enlarged details of FIG. 1.

### DETAILED DESCRIPTION OF THE PREFERRED EMBODIMENTS

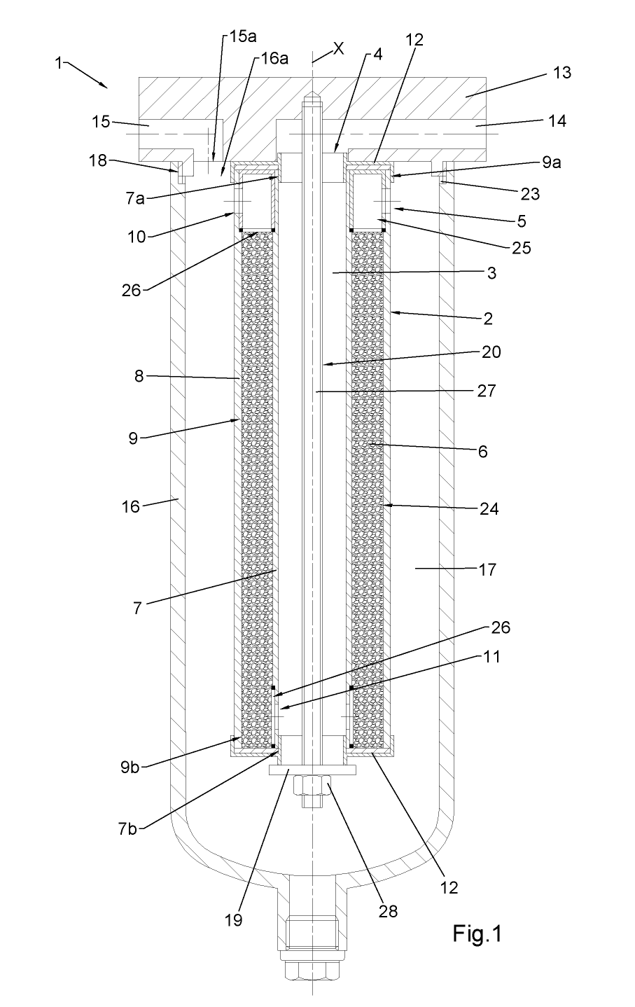

According to a first aspect of the invention, the same concerns a purification device indicated as a whole by 1 in FIG. 1, which comprises a hollow body 2 defining a duct 3 for conveying water.

The duct 3 is developed between a first mouth 4 and a second mouth 5. Furthermore, the purification device 1 comprises a purifying material 6 arranged in a first area 24 in the duct 3, between the first mouth 4 and the second mouth 5.

According to the invention, the purifying material 6 is graphene.

As is known, graphene is a material constituted by a single layer of carbon atoms arranged according to the structure of graphite. The applicant filing the present invention has discovered that the material mentioned above can be used to make a water filter.

In particular, it has been observed that graphene is capable of holding back the glycol suspended in water, thus achieving one of the objects of the invention.

The graphene is held in the first area 24 by holding elements 26, in such a way that it can come into contact with water without being carried away by the latter.

It can be understood that the purification device 1 can be connected to a duct which conveys contaminated water immediately downstream of the production point and, therefore, achieves one of the objects of the invention.

Furthermore, the extreme simplicity of the purification device 1, combined with the fact that it makes it possible to eliminate the need to provide a duct for conveying contaminated water from the production point to a purification system, allows the further object to limit the cost of the purification device itself to be achieved.

Preferably, the graphene used takes on the shape of a plurality of independent plate-like elements which fill the first area 24.

The holding elements 26 comprise two water-permeable walls 21, 22 which prevent the passage of said plate-like elements and delimit the first area 24 on corresponding opposite sides which respectively face towards the first mouth 4 and towards the second mouth 5. Preferably, said water-permeable walls 21, 22 comprise respective grids.

Still preferably, the ratio between the mass of said plate-like elements and the volume of the first area 24 is included between 15 and 50 mg/cm3. Laboratory tests carried out by the applicant filing the present invention have shown that said ratio makes it possible to obtain optimal purification results.

According to a variant embodiment of the invention not illustrated in the drawings, the holding elements 26 comprise a supporting film arranged in the first area 24 and associated with graphene. Advantageously, the supporting film holds the graphene in a predefined position, preventing any movement of the latter.

Preferably, the supporting film is wound in a spiral or folded on itself in such a way as to increase the surface of graphene that comes into contact with water and, consequently, the filtering power of the device 1.

Preferably, the hollow body 2 comprises an inner tubular jacket 7 connected in a stable manner to an outer tubular jacket 8 which surrounds the first one and which, preferably but not necessarily, is coaxial with it. Therefore, a first air space 9 which extends according to a longitudinal direction X between two opposite ends 9a, 9b is defined between the two jackets 7 and 8. The first air space 9 belongs to the duct 3 and comprises said first area 24 in which the purifying material 6 is placed.

The connection between the inner jacket 7 and the outer jacket 8 is preferably obtained by means of terminal plates 12 which are mutually opposite each other with respect to the first air space 9 and connect each end 7a, 7b of the inner jacket 7 to a corresponding end of the outer jacket 8.

Preferably, the terminal plates 12 are connected to the inner and outer tubular jackets 7 and 8 in a tight manner, for example by means of gaskets or in other manners.

It is obvious that in variant embodiments of the invention not illustrated in the drawings the configuration of the hollow body 2 can be different from that described above, provided that it is suited to define an area where the graphene can be confined.

The hollow body 2 also comprises one or, more preferably, a plurality of first holes 10 which place the first air space 9 in communication with the outside of the outer tubular jacket 8. Preferably, said first holes 10 are distributed radially, in a more or less uniform manner, around the outer tubular jacket 8, in such a way as to facilitate the passage of water. Obviously, the first holes 10 can be present in any number and variant embodiments of the invention may even be provided with a single first hole 10.

The inner volume of the inner tubular jacket 7 communicates with the first air space 9 through a plurality of second holes 11. What has just been said with reference to the first holes 10 applies also to the arrangement and number of the second holes 11.

Preferably, the first holes 10 are through holes belonging to the outer tubular jacket 8. Still preferably, the second holes 11 are through holes belonging to the inner tubular jacket 7.

Still preferably, the first holes 10 are arranged nearer to a first end 9a of the first air space 9 than to the opposite end 9b, and vice versa for the second holes 11. Obviously, the nearer the first holes 10 to the first end 9a and the nearer the second holes 11 to the second end 9b, the larger the portion of the length of the first air space 9 which is available for the purification process and, consequently, the higher the efficiency of the latter.

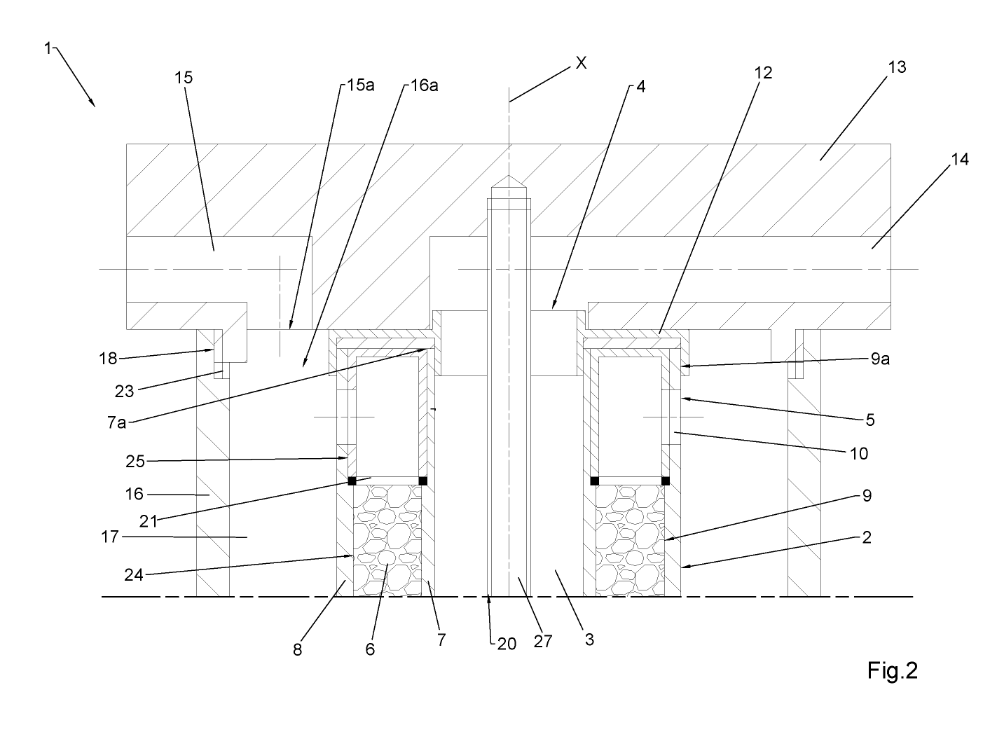

Preferably and as shown in FIG. 2, the inner tubular jacket 7 is provided with a first open end 7a which defines the first mouth 4, while the second mouth 5 corresponds to the first holes 10. Furthermore, a supporting body 13 is provided which defines a first channel 14 for the water, wherein the supporting body 13 can be associated with the inner tubular jacket 7 in such a way that the first channel 14 is in communication with said first open end 7a.

Preferably, the supporting body 13 is associated with the inner tubular jacket 7 by means of a sealing element, for example a gasket not illustrated in the drawings but known per se, which is suited to prevent the water to be filtered from being mixed with the filtered water. Said sealing element can be incorporated in a corresponding one of said terminal plates 12.

Preferably, the supporting body 13 comprises also a second channel 15 for the water, provided with an end 15a. When the supporting body 13 is associated with the first open end 7a, said end 15a of the second channel 15 is arranged outside the outer tubular jacket 8 in such a way that it communicates with the first holes 10.

Preferably, there is also a container 16 provided with an opening 16a for the insertion of the hollow body 2. The opening 16a can be tightly coupled with the supporting body 13, for example by means of a gasket 23, in such a way as to prevent the outflow of water from the container 16 itself.

In particular, the container 16 is configured in such a way that, when it is associated with the supporting body 13 and the latter is associated with the inner tubular jacket 7, the container 16 and the outer tubular jacket 8 delimit a second air space 17 that connects the first holes 10 to the second channel 15.

In the configuration described above, said channels 14 and 15 respectively make it possible to introduce the water to be filtered into the hollow body 2 and to extract the filtered water from the same, or vice versa.

Advantageously, the fact that the channels 14 and 15 are both created in the supporting body 13 and that the latter is associated with the container 16 allows the active element to be easily replaced.

In fact, it is sufficient to remove the container 16 from the supporting body 13 and separate the hollow body 2 from the supporting body 13 in order to replace it with a new or regenerated one, thus achieving one of the objects of the invention.

For this purpose, the container 16 is removably associated with the supporting body 13 through a coupling element 18 which, preferably but not necessarily, comprises threads belonging to the container 16 and to the coupling element 18 and mutually matching each other, which allow the container 16 to be unscrewed from the supporting body 13 and removed.

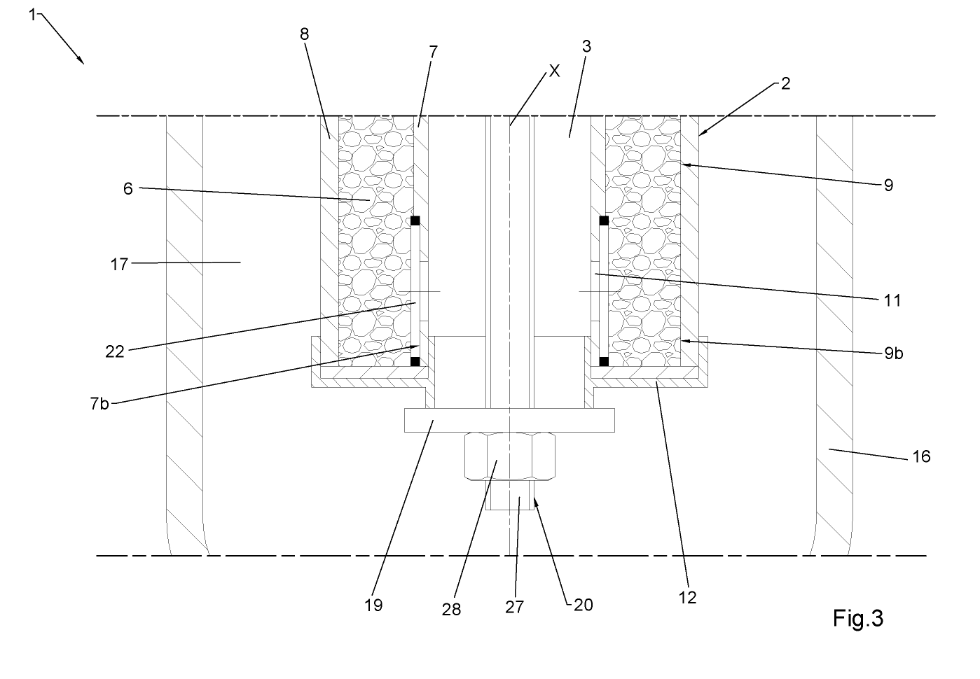

As regards the second end 7b of the inner tubular jacket 7 opposite said first open end 7a, preferably and as shown in FIG. 3 it is closed by means of a removable cap 19.

Preferably, the removable cap 19 is connected in a stable manner to the supporting body 13 through a connection element 20 configured in such a way that the stable connection of the removable cap 19 to the supporting body 13 holds the inner tubular jacket 7 on the supporting body 13 itself in a stable manner. This advantageously allows the hollow body 2 to be quickly connected to the supporting body 13.

Preferably but not necessarily, the connection element 20 is a threaded tie rod 27 arranged in the inner tubular jacket 7, one end of which is screwed into a corresponding nut screw belonging to the supporting body 13, while the opposite end houses a nut 28 suited to hold said removable cap 19. In this way, the removal of the cap 19 and of the hollow body 2 is obtained by simply unscrewing said nut 28.

In variant embodiments of the invention, the connection element 20 can be a bolt one end of which is provided with a head suited to hold the removable cap 19.

In the variant embodiment of the purification device 1 in which the graphene used assumes the shape of independent plate-like elements, a first water-permeable wall 21 is preferably arranged in the first air space 9, in such a way as to separate the first area 24 from a second area 25 of the first air space 9 adjacent to the first holes 10, so that the second area 25 is free from graphene. Therefore, if the water flow is directed from the second holes 11 towards the first holes 10, said second area 25 advantageously makes it possible to avoid any accumulation of graphene towards the first holes 10, thus preventing the obstruction of the latter. Obviously, if the water flow takes place in the opposite direction with respect to the description just provided above, the same effect can be obtained by arranging the second area 25 in such a way that it is adjacent to the second holes 11.

In the variant embodiment of the purification device 1 in which the graphene used is associated with a supporting film, the latter is preferably wound in a spiral around the inner tubular jacket 7, in such a way that it is possible to exploit the volume of the first air space 9 and thus maximize the graphene surface that comes into contact with water and therefore the efficiency of the purification process.

As regards the material making up the purification device 1, it is preferably a plastic material, even more preferably a plastic material suited to resist temperatures exceeding 100° C., in such a way as to allow steam to be used to regenerate graphene.

Still preferably, the hollow body 2 is made in such a way that it can be handled as a single body. This applies in particular to the inner tubular jacket 7, the outer tubular jacket 8, the terminal plates 12, the purifying material 6 and the corresponding holding elements 26, which are all fixed together. This allows the hollow body 2 to be used as a cartridge and facilitates its replacement.

When said components are made of plastic, they can be mutually fixed to each other, for example, through a heat sealing operation.

According to a different aspect of the invention, the same concerns a water purification method according to which the water containing a contaminating substance is conveyed through a duct 3 and filtered in the duct 3 itself in such a way as to hold back the contaminating substance.

According to the invention, said operation of filtering water is carried out by means of graphene, which is placed in the duct 3.

Preferably but not necessarily, the contaminating substance comprises glycol, against which graphene has proven to exert an optimal purifying action.

Preferably but not necessarily, graphene is placed in a purification device 1 of the type described above.

To regenerate graphene, preferably a regenerating fluid suited to remove the contaminating substance is made flow through the graphene itself.

Said regenerating fluid preferably comprises steam.

According to a first embodiment, the regeneration process takes place on site, after a temporary interruption of the water flow along the duct 3 and at the same time as the regenerating fluid flows through the graphene.

According to a variant embodiment, the regeneration process takes place in a special dedicated system and not on site, after the removal of the hollow body 2 and its replacement with a new or regenerated hollow body.

According to the description provided above, it can be understood that the device and the method for filtering water described above achieve all the objects of the invention.

In fact, the invention makes it possible to carry out the water purification process directly on site, making it less expensive compared to the use of large purification systems located far away from the production points.

Furthermore, the use of graphene makes it possible to reduce the content of glycol in water.

Furthermore, the use of a hollow body in a single piece removably connected to the water conveying duct as active element makes it possible, when necessary, to quickly replace the active element itself with a new or regenerated active element, in addition to allowing it to be easily regenerated.

1. A purification device comprising:
a hollow body which defines a duct suited to convey water, said duct being developed between a first mouth and a second mouth;
a purifying material placed in a first area of said duct between said first mouth and said second mouth;
said purifying material being graphene, said graphene being held inside said first area by means of one or more holding elements;
said hollow body comprising:
an inner tubular jacket;
an outer tubular jacket connected in a stable manner to said inner tubular jacket on the outside of the latter, in such a way that between said outer tubular jacket and said inner tubular jacket a first air space is defined which belongs to said duct, said first air space extending along a longitudinal direction (X) between two opposite ends and comprising said first area;
one or more first holes suited to place said first air space in communication with the outside of said outer tubular jacket;
one or more second holes suited to place the inner volume of said inner tubular jacket in communication with said first air space, said purifying material being arranged in said first air space;
said graphene taking on the shape of a plurality of independent plate-like elements, said holding elements being two water-permeable walls suited to prevent the passage of said plate-like elements and delimiting said first area on corresponding opposite sides respectively facing towards said first mouth and towards said second mouth;
wherein:
the ratio between the mass of said plate-like elements and the volume of said first area is included between 15 and 50 mg/cm³, and
a first one of said two water-permeable walls is arranged in said first air space and separates said first area from a second area of said first air space adjacent to said first holes in such a way as to maintain said second area free from said graphene.

2. (canceled)

3. The purification device according to claim 1, wherein each one of said two water-permeable walls comprises a corresponding grid.

4. The purification device according to claim 1, wherein said first holes are arranged nearer to a first one of said two opposite ends than to the second one, and in that said second holes are arranged nearer to said second end than to said first end.

5. The purification device according to claim 1, wherein said inner tubular jacket is provided with at least one first open end (7a) corresponding to said first mouth, wherein said first holes correspond to said second mouth, a supporting body with a first channel for said water being provided, said supporting body being suited to be tightly associated with said inner tubular jacket in such a way that said first channel is in communication with said first open end.

6. The purification device according to claim 5, wherein said supporting body comprises a second channel for said water, provided with an end which communicates with said first holes when said supporting body is associated with said first open end.

7. The purification device according to claim 5, further comprising a container provided with an opening for the insertion of said hollow body, said opening being suited to be tightly coupled with said supporting body, said container being configured in such a way that, when said supporting body is associated with said inner tubular jacket and said container is associated with said supporting body, said container and said outer tubular jacket delimit a second air space which places said first holes in communication with said second channel.

8. The purification device according to claim 7, further comprising a coupling element suited to removably associate said container with said supporting body.

9. The purification device according to claim 5, wherein the second end of said inner tubular jacket opposite said first open end is closed by means of a removable cap.

10. The purification device according to claim 9, further comprising a connection element suited to connect said removable cap to said supporting body in a stable manner, in such a way as to obtain the stable connection of said inner tubular jacket to said supporting body.
